(19) United States
(12) Patent Application Publication
(10) Pub. No.: US 2006/0111991 A1
(43) Pub. Date: May 25, 2006

(54) Confindential information sharing system

(76) Inventors: Murray Wilshinsky, Jerusalem (IL); Arie Sagi, Cochav Yair (IL); Steve Gasner, Jerusalem (IL)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/520,603

(22) PCT Filed: Jul. 8, 2003
(86) PCT No.: PCT/IL03/00562

§ 371 Date: Nov. 18, 2005

Related U.S. Application Data
(60) Provisional application No. 60/394,707, filed on Jul. 8, 2002.

(51) Int. Cl. G06Q 40/00; G07G 1/00; G06Q 99/00; G06F 17/30

(52) U.S. Cl. 705/35; 705/1; 705/10

(57) ABSTRACT

Improved confidential information sharing systems, including a first plurality of data collection units (108), each collecting confidential data regarding a second plurality of individual entities, a third plurality of data consumer units which intermittently require confidential data collected by ones of the first plurality of data collection units regarding ones of the second plurality of individual entities (108 & 110); and at least one confidential data sharing interface (102 & 106), responsive to a requirement from one of the third plurality of data consumer units for confidential data from one of the first plurality of data collection units (100) regarding one of the second plurality of individual entities (110), to pull confidential data from an appropriate one of the first plurality of data collection units (100) regarding a specific individual entity (110).

### FIELD OF THE INVENTION

The present invention relates to information systems generally, and more particularly to information sharing systems.

### BACKGROUND OF THE INVENTION

U.S. Pat. Nos. 6,311,169 and 6,249,775 are believed to represent the current state of the art.

### SUMMARY OF THE INVENTION

The present invention seeks to provide improved confidential information sharing systems.

There is thus provided in accordance with a preferred embodiment of the present invention a confidential information sharing system including a first plurality of data collection units, each collecting confidential data regarding a second plurality of individual entities, a third plurality of data consumer units which intermittently require confidential data collected by ones of the first plurality of data collection units regarding ones of the second plurality of individual entities; and at least one confidential data sharing interface, responsive to a requirement from one of the third plurality of data consumer units for confidential data from one of the first plurality of data collection units regarding one of the second plurality of individual entities, to pull confidential data from an appropriate one of the fist plurality of data collection units regarding a specific individual entity.

There is also provided in accordance with another preferred embodiment of the present invention a confidential information sharing system including a first plurality of confidential data collection units, each collecting confidential information regarding a second plurality of individual entities, a third plurality of confidential data consumer units which intermittently require confidential data collected by ones of the first plurality of confidential data collection units regarding ones of the second plurality of individual entities and at least one confidential data sharing interface, operative on line to provide confidential data to one of the third plurality of confidential data consumer units from one of the first plurality of confidential data collection units regarding one of the second plurality of individual entities regarding a specific individual entity.

There is further provided in accordance with another preferred embodiment of the present invention a confidential information sharing system including a first plurality of confidential data collection units, each collecting confidential information regarding a second plurality of individual entities, a third plurality of confidential data consumer units which intermittently require confidential data collected by ones of the first plurality of confidential data collection units regarding ones of the second plurality of individual entities and at least one confidential data sharing interface, operative on line to provide confidential data from one of the first plurality of confidential data collection units regarding a specific individual entity.

There is still further provided in accordance with another preferred embodiment of the present invention a confidential information sharing system including a first plurality of confidential data collection units, each collecting confidential information regarding a second plurality of individual entities, a third plurality of confidential data consumer units which intermittently require confidential data collected by ones of the first plurality of confidential data collection units regarding ones of the second plurality of individual entities and at least one confidential data sharing interface, operative on line to provide confidential data from one of the first plurality of confidential data collection units regarding one of the second plurality of individual entities.

There is yet further provided in accordance with another preferred embodiment of the present invention a commercial system including a first plurality of credit confidential data collection units, each collecting confidential credit information regarding a second plurality of individual entities and at least one credit confidential data receiver, receiving credit confidential data from ones of the first plurality of confidential data collection units regarding ones of the second plurality of individual entities and for directing offers to the ones of the second plurality of individual entities based on said credit confidential data specific to each of said ones of the second plurality of individual entities.

There is also provided in accordance with yet another preferred embodiment of the present invention a loan securitizing system including a first plurality of confidential data collection units, each collecting confidential information regarding a second plurality of loans to individual entities and at least one loan securitizing system receiving on line information from the first plurality of confidential data collection units and being operative to provide consolidated information regarding at least one collection of loans within the second pluralities of loans and being operative, based on the consolidated information to enable enhanced ease of securitizing the at least one collection of loans.

There is further provided in accordance with still another preferred embodiment of the present invention a method for sharing confidential information including collecting confidential data regarding a first plurality of individual entities from a second plurality of data collection units, storing the confidential data and sharing the confidential data, via at least one confidential data sharing interface, the sharing including receiving a request from one of a third plurality of data consumer units, for individual entity specific confidential data regarding one of the first plurality of individual entities from at least one of the second plurality of data collection units, collecting the individual entity specific confidential data from appropriate ones of the second plurality of data collection units and transmitting the individual entity specific confidential data to the one data consumer unit.

There is still further provided in accordance with yet another preferred embodiment of the present invention a method for sharing confidential information including collecting confidential data regarding a first plurality of individual entities from a second plurality of data collection units, storing the confidential data and sharing the confidential data, via at least one confidential data sharing interface, the sharing including receiving an on-line request, from one of a third plurality of data consumer units, for individual entity specific confidential data regarding one of the first plurality of individual entities from at least one of the second plurality of data collection units collecting the individual entity specific confidential data from appropriate ones of the second plurality of data collection units and transmitting the individual entity specific confidential data on-line to the one data consumer unit.

There is yet further provided in accordance with another preferred embodiment of the present invention a method for sharing confidential information including collecting confidential data regarding a first plurality of individual entities from a second plurality of data collection units, storing the confidential data and sharing the confidential data, via at least one confidential data sharing interface, the sharing including receiving an on-line request for individual entity specific confidential data regarding one of the first plurality of individual entities from at least one of the second plurality of data collection units, collecting the individual entity specific confidential data from appropriate ones of the second plurality of data collection units and transmitting the individual entity specific confidential data on-line.

There is still further provided in accordance with yet another preferred embodiment of the present invention a commercial method including collecting confidential credit data regarding a first plurality of individual entities from a second plurality of credit confidential data collection units, storing the confidential credit data and receiving the confidential credit data, at least one credit confidential data receiver, the receiving including collecting the confidential credit data from appropriate ones of the second plurality of data collection units regarding ones of the second plurality of individual entities and directing offers to the ones of the second plurality of individual entities based on the credit confidential data specific to each of the ones.

There is yet further provided in accordance with still another preferred embodiment of the present invention a method for loan securitizing including collecting confidential data, from a first plurality of confidential data collection units, regarding a second plurality of loans to individual entities, storing the confidential data, receiving, on line, from the first plurality of confidential data collection units, a portion of the confidential data regarding at least one collection of loans within the second pluralities of loans, consolidating the portion of the confidential data, enabling enhanced ease of securitizing the at least one collection of loans, based on the consolidated information.

In accordance with a preferred embodiment of the current invention the at least one data sharing interface is operative to pull confidential data only following completion of privacy waiver functionality. Preferably, the privacy waiver functionality is individual entity specific. Alternatively or additionally, the privacy waiver functionality is data consumer unit specific.

Preferably, the confidential data is credit rating relevant confidential data.

In accordance with a preferred embodiment of the current invention the at least one confidential data sharing interface comprises payment functionality. Preferably, the payment functionality includes functionality for processing payments to the first plurality of confidential data collection units in respect of confidential data collected therefrom. Additionally or alternatively, the payment functionality includes functionality for processing payments from the third plurality of confidential data consumer units in respect of confidential data provided thereto.

In accordance with another preferred embodiment of the current invention the payment functionality includes a cash payment functionality. Alternatively, the payment functionality includes a barter functionality.

In accordance with a preferred embodiment of the current invention the at least one confidential data sharing interface includes advertising functionality. Preferably, the advertising functionality includes automatic targeted advertising functionality for targeting ones of the third plurality of confidential data consumer units in accordance with at least one characteristic thereof.

In accordance with another preferred embodiment of the current invention the at least one confidential data sharing interface includes automatic profiling functionality. Preferably, the profiling functionality includes individual entity profiling functionality. Additionally, the profiling functionality also includes automatic individual entity classification functionality employing the individual entity profiling functionality for classifying individual entities according to the confidential data.

In accordance with a preferred embodiment of the current invention the first plurality of confidential data collection units includes at least one of banks, credit unions, finance companies, credit card companies, installment loan companies, mortgage lenders and lessors. Additionally or alternatively, the second plurality of individual entities includes at least one of individual persons, unincorporated business entities and incorporated entities. Additionally or alternatively, the third plurality of confidential data consumer units includes at least one of individual persons belonging to said second plurality, individual persons not belonging to said second plurality, banks, credit unions, finance companies, credit card companies, installment loan companies, mortgage lenders, potential employers and lessors.

In accordance with yet another preferred embodiment of the current invention the confidential information sharing system also includes an individual entity interface enabling individual ones of the second plurality of individual entities to obtain access to confidential data relating to themselves.

Preferably, the individual entity interface includes an individual entity annotation input functionality, enabling individual ones of the second plurality of individual entities to enter annotations to the confidential data relating to themselves. Additionally, the individual entity interface may include an individual entity confidential data tracing functionality, enabling individual ones of the second plurality of individual entities to trace the confidential data relating to themselves. Alternatively, the individual entity confidential data tracing functionality enables individual ones of the second plurality of individual entities to determine the origin of the confidential data relating to themselves.

In accordance with a preferred embodiment of the current invention the individual entity annotation input functionality enables individual ones of the first plurality of data collection units to view the annotations. Additionally, the individual entity annotation input functionality may also enable individual ones of the first plurality of data collection units to view the annotations together with the related confidential data. Additionally or alternatively, the individual entity annotation input functionality may enable individual ones of the first plurality of data collection units to respond to the annotations.

In accordance with yet another preferred embodiment of the current invention the individual entity annotation input functionality enables individual ones of the second plurality of individual entities to interact with the first plurality of data collection units in relation to the annotations.

In accordance with still another preferred embodiment of the current invention the individual entity annotation input functionality enables individual ones of the second plurality of individual entities to store information relating to themselves, which information may be made available together with the confidential data.

In accordance with a preferred embodiment of the current invention the system is implemented on a distributed network. Additionally, the distributed network may comprise remote databases as well as segmented databases. Alternatively, the distributed network may comprise multiple databases resident on a single computer.

### BRIEF DESCRIPTION OF THE DRAWINGS

The present invention will be understood and appreciated more fully from the following detailed description, taken in conjunction with the drawings in which:

FIG. 1 is a simplified pictorial illustration showing various functionalities forming part of a confidential information sharing system and method constructed and operative in accordance with a preferred embodiment of the present invention;

FIGS. 2A and 2B are simplified flow charts showing the operation of a data collection unit interface constructed and operative in accordance with a preferred embodiment of the present invention;

FIG. 3 is a simplified flow chart showing the operation of a confidential information sharing system and method, including privacy functionality, constructed and operative in accordance with a preferred embodiment of the present invention;

FIG. 4 is a simplified flow chart showing the operation of a payment functionality that forms part of a confidential information sharing system and method constructed and operative in accordance with a preferred embodiment of the present invention;

FIG. 5 is a simplified flow chart showing the operation of a profiling functionality that forms part of a confidential information sharing system and method constructed and operative in accordance with a preferred embodiment of the present invention; and

FIGS. 6A and 6B are simplified flow charts showing the operation of an advertising functionality that forms part of a confidential information sharing system and method constructed and operative in accordance with a preferred embodiment of the present invention.

### DETAILED DESCRIPTION OF PREFERRED EMBODIMENTS

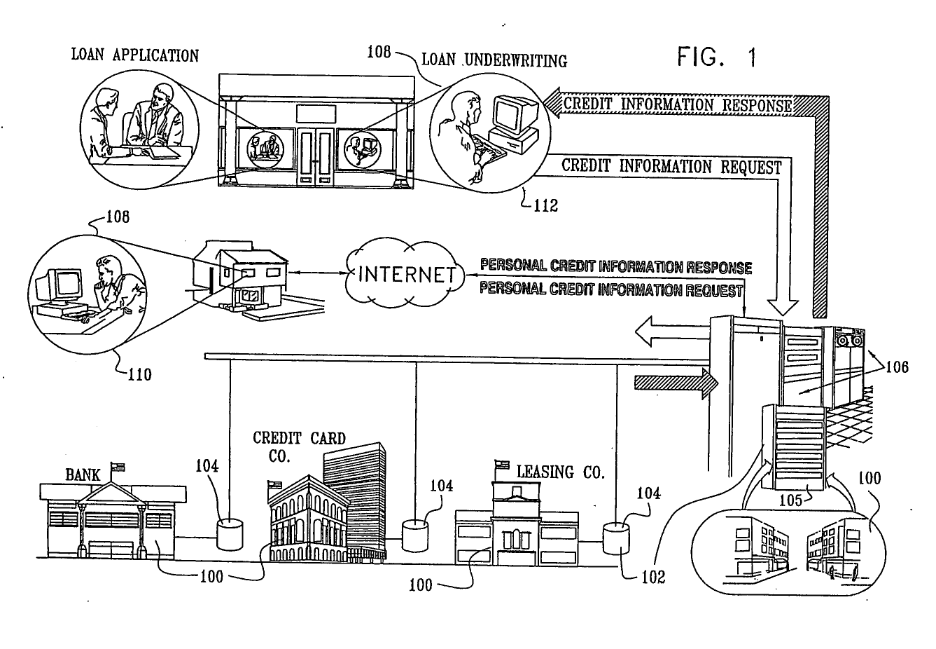

Reference is now made to FIG. 1, which is a simplified pictorial illustration showing various functionalities forming part of a confidential information sharing system and method constructed and operative in accordance with a preferred embodiment of the present invention. As seen in FIG. 1, a plurality of confidential data collection units 100, such as banks, credit card companies, and other data collectors, collect confidential data relating to individual entities, such as consumers and businesses. The confidential data, typically credit rating related confidential data, may include bank loan transaction records, utility payment records, credit card payment records or any other suitable data. In accordance with a preferred embodiment of the present invention, a plurality of data collection unit interfaces 102 are operative to collect and store the data received from the data collection units 100.

The data collection unit interfaces 102 may include data collection nodes 104, typically dedicated to a single data collection unit 100, or data collection racks 105, typically shared among multiple data collection units 100. The data collection racks 105 may aggregate data from one or more data collection nodes 104, or may include data collection controllers controlling a multiplicity of other suitable data collectors.

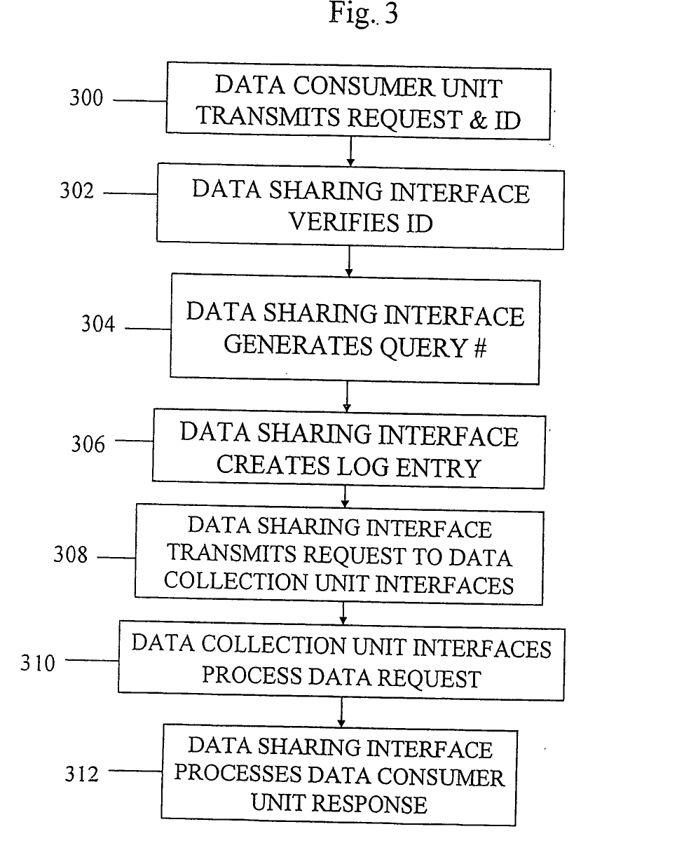

The confidential information sharing system also includes a data sharing interface 106, through which a plurality of confidential data consumer units 108 are able to request confidential data. The data sharing interface 106 communicates with the data collection unit interfaces 102, as described in reference to FIG. 3 hereinbelow, to retrieve the relevant confidential data stored therein. The data sharing interface 106 may be embodied in a conventional system or as a software agent. The data collection unit interfaces 102 may include conventional data storage and retrieval devices, which may be co-located with the data collection unit 100 data facility or the data sharing interface 106, or may be embodied as a software functionality incorporated into the data sharing interface 106.

As seen in FIG. 1, the plurality of confidential data consumer units 108 typically comprises individual entities 110, such as consumers or small business entities, typically requesting data relating to their own credit rating, and other data consumers 112, such as loan underwriters or credit granting entities, typically requesting data relating to a specific individual entity 110.

Thus, as seen in FIG. 1, an individual consumer 110 may access the confidential information sharing system through the data sharing interface 106 to request their personal credit information. The data sharing interface 106 then communicates with the plurality of data collection unit interfaces 102, as described hereinbelow in reference to FIG. 3, to generate a response to the personal credit information request.

In another preferred embodiment seen in FIG. 1, a loan underwriter 112 may access the confidential information sharing system through the data sharing interface 106 to request credit information concerning an individual loan applicant. The data sharing interface 106 then communicates with the plurality of data collection unit interfaces 102, as described hereinbelow in reference to FIG. 3, to generate the requested credit information.

In accordance with still another preferred embodiment of the present invention, the data sharing interface 106 may collect and store data from the individual entities 110, typically annotations relating to specific entries in their own confidential data, as well as from the data collection units 100, typically responses to the data consumer unit annotations. The annotations and responses may be linked to the specific confidential data entries to which they relate, which may allow for the annotations to then be accessed together with the entries. In a further embodiment, the data sharing interface 106 may also facilitate interaction between an individual entity 110 and an individual data collection unit 100 in relation to the above annotations and responses.

The data structure which supports the flow of data described in FIG. 1 may be implemented via conventional data networking technology, such as the internet or other conventional data networking systems. Alternatively, the data structure may be embodied using a distributed network, which may include remote databases, segmented databases and/or multiple databases resident on a single computer. In accordance with another preferred embodiment, the confidential information sharing system may be accessed on-line. In yet another embodiment, the data sharing interface 106 may be a software agent enabling peer-to-peer interaction between the data consumer unit 108 and the data collection unit interfaces 102.

It is appreciated, that, in accordance with the preferred embodiments of the present invention, the data collection unit interfaces 102 control the data which flows from the data collection units 100 to the data sharing interface 106 and that access to the data collection unit interfaces 102 is controlled by the data sharing interface 106, which transmits the data consumer unit data requests to the data collection unit interfaces 102. The data sharing interface 106 may also aggregate the data and/or perform other suitable operations on the data to appropriately respond to the data consumer data requests.

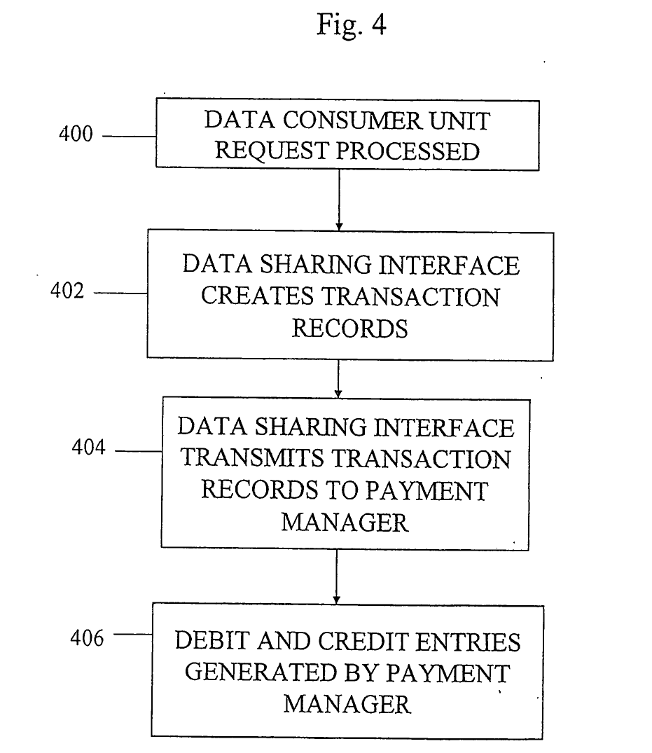

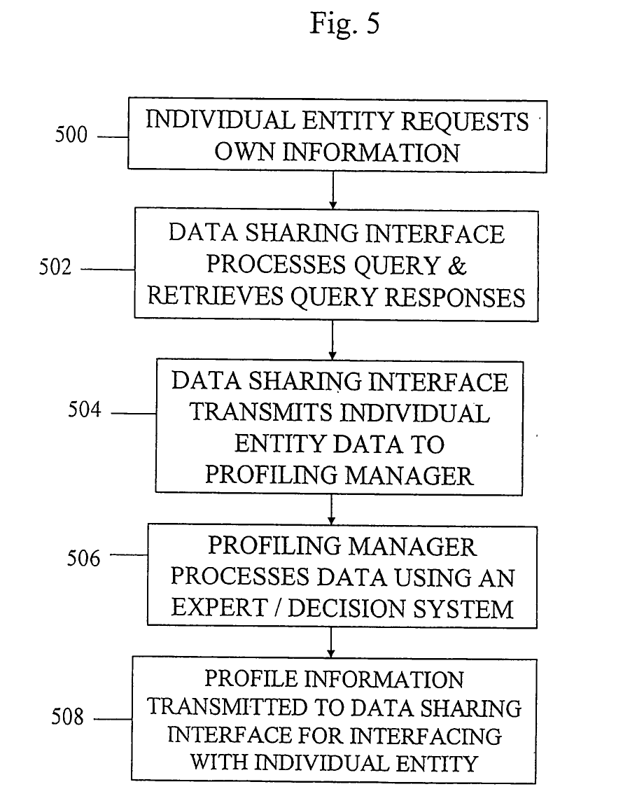

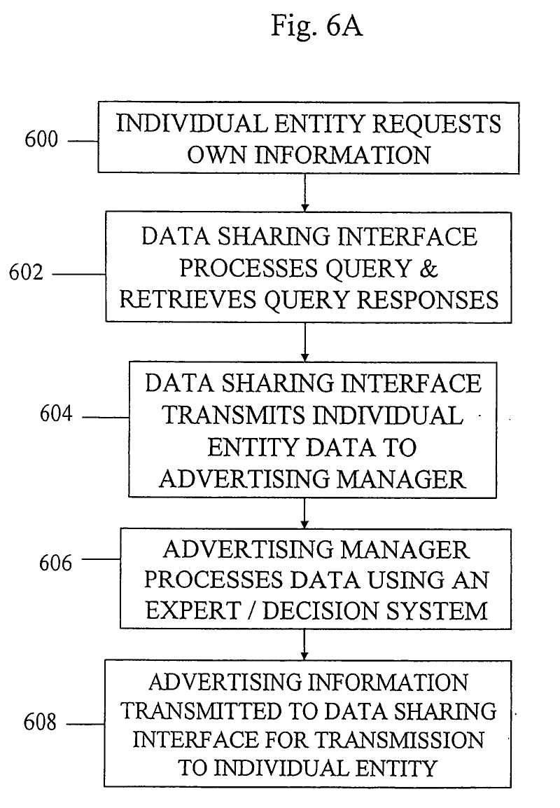

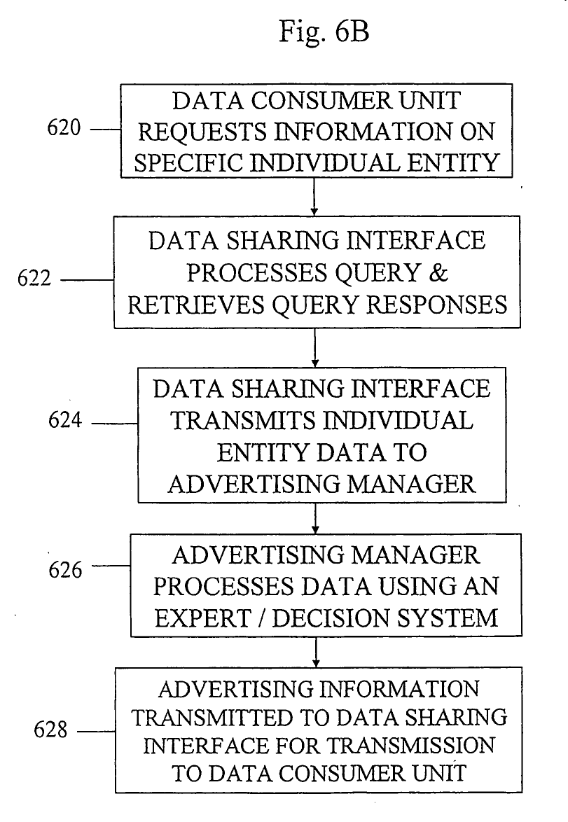

In another preferred embodiment, the data sharing interface 106 may also communicate with additional functionality managers, such as a payment manager, as described hereinbelow in reference to FIG. 4, a profiling manager, as described hereinbelow in reference to FIG. 5, or an advertising manager, as described hereinbelow in reference to FIGS. 6A and 6B. Alternatively, these functionalities may be incorporated into the data sharing interface 106.

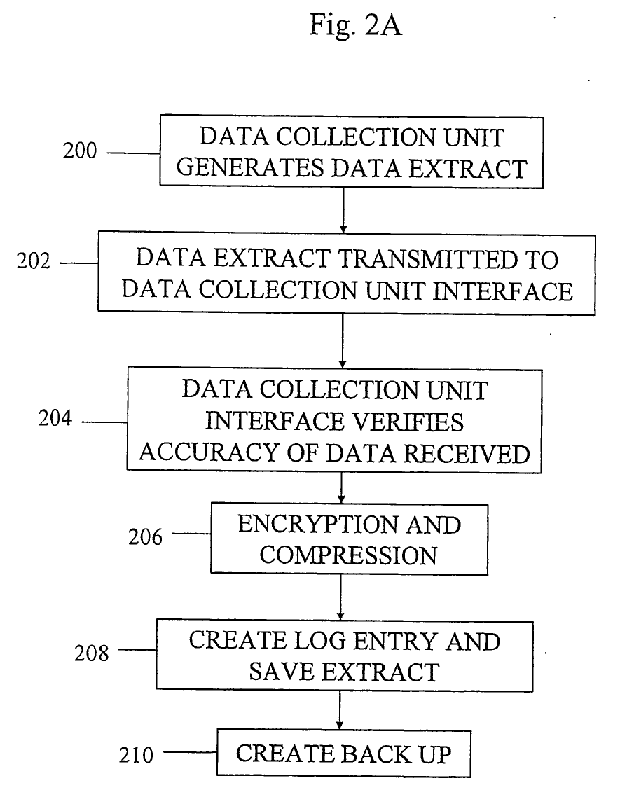

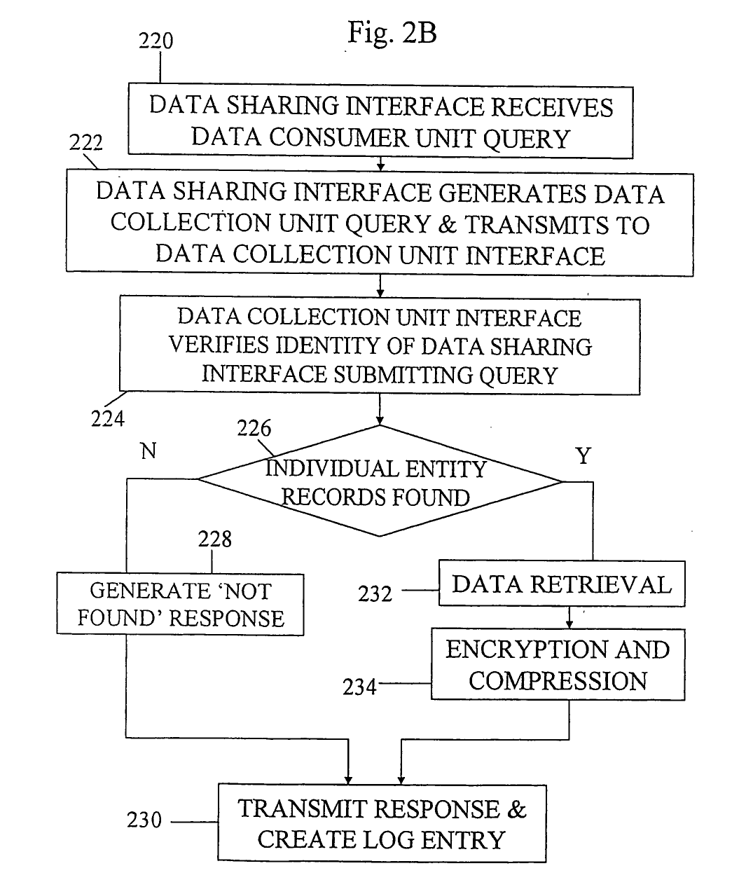

Reference is now made to FIG. 2A, which is a simplified flow chart showing the operation of a data collection functionality of a data collection unit interface 102 constructed and operative in accordance with a preferred embodiment of the present invention. It is appreciated that the content and the format of the data to be provided, from the data collection unit 100, to the data collection unit interface 102, for access by the data sharing interface 106, as well as the frequency of its provision, have been agreed upon prior to the operation of the data collection functionality. It is also appreciated that the frequency of the operation of the data collection functionality is, preferably, a function of the volume of data generated by the data collection unit and may vary from data collection unit to data collection unit. It is further appreciated that the content and format of the data being provided may vary from data collection unit to data collection unit.

As seen in FIG. 2A, in block 200, the data collection unit 100 generates a data extract according to the agreed upon specifications. The data extract is then transmitted, as shown in block 202, to the data collection unit interface 102. The data collection unit interface 102 then verifies the accuracy of the data, in block 204, using conventional verification techniques, and prepares the data for storage, typically including compression and encryption of the data, as seen in block 206.

Preferably, the data collection unit interface 102 then creates a log record, typically including appropriate data extract tracking information, recording the receipt of the extract, and saves the log record together with data extract, as shown in block 208. Additionally, as indicated in block 210, the data collection unit interface 102 preferably creates a back-up copy of the log record and the data extract to provide for recovery in the event of a system emergency.

All of the above referenced functions may be performed employing conventional systems and methodologies.

Reference is now made to FIG. 2B, which is a simplified flow chart showing the operation of a data query response function of a data collection unit interface 102 constructed and operative in accordance with a preferred embodiment of the present invention. In block 220, the data sharing interface 106 receives a data query pertaining to a specific individual entity 110 from an authorized data consumer unit 108. The data sharing interface 106 then generates a data collection unit query which is transmitted in block 222 to the data collection unit interface 102. In block 224, the data collection unit interface 102 verifies the identity of the data sharing interface 106 making the request.

In block 226, the data collection unit interface 102 searches for data records pertaining to the individual entity 110 requested. If no records are found in the search, the process continues in block 228, where the data collection unit interface 102 generates an ‘entity not found’ response. Control then proceeds to block 230, where the data collection unit interface 102 transmits the ‘entity not found’ response to the data sharing interface 106 and creates a log record of the transmission of the query response.

If records are found in the search in block 226, the process continues in block 232, where the data collection unit interface 102 retrieves the relevant data. The data is then compressed and encrypted in block 234. In block 230, the data collection unit interface 102 transmits the query response to the data sharing interface 106 and creates a log record of the transmission of the query response.

All of the above referenced functions may be performed employing conventional systems. Additionally, the data collection unit interfaces 102 preferably include ‘firewall’ and/or other appropriate security protection to ensure that the data collection unit confidential data is accessed only by authorized users, requesting data through the data sharing interface 106.

Reference is now made to FIG. 3, which is a simplified flow chart showing the operation of a confidential information sharing system, including privacy functionality, constructed and operative in accordance with a preferred embodiment of the present invention. In block 300, a confidential data consumer unit 108, such as a loan underwriter 112 or other credit granting agency 112, requests confidential data relative to a specific individual entity 110 from the data sharing interface 106, after receiving authorization from the individual entity 110. Preferably, the individual entity authorization includes a machine readable identification, such as a driver's license, which is also transmitted to the data sharing interface 106. In addition, the confidential data consumer unit 108 also transmits identification information, preferably, by providing a machine readable identification, to the data sharing interface 106 along with the data request to be processed.

In block 302, the data sharing interface 106 receives the request and verifies the authenticity of the data consumer unit 108, as well as the authenticity of the individual entity 110 whose confidential data is being requested. The data sharing interface 106 generates a unique query number in block 304 and, in block 306, creates a log record of the request including date and time stamp, the data consumer unit 108, the individual entity 110 whose confidential data is being requested, and the unique query number generated in block 304. In block 308, the data sharing interface 106 communicates the request to the data collection unit interfaces 102. In block 310, the data collection unit interfaces 102 process the query as described in FIG. 2B hereinabove. In block 312, the data sharing interface 106 performs the required operations, such as aggregation and data manipulation, based on the responses from the data collection unit interfaces 102, to generate the data consumer unit response.

In another preferred embodiment of the present invention, the confidential data consumer unit 108, referenced above in block 300, is an authorized individual entity 110 requesting confidential information relative to itself, where the authorization may also include a conventional identification recognition methodology, such as user name and password recognition, and/or biometric identification.

Reference is now made to FIG. 4, which is a simplified flow chart of a payment function, which forms part of a confidential information sharing system constructed and operative in accordance with a preferred embodiment of the present invention. In this embodiment, the data sharing interface 106 communicates with a payment manager, which is operative to debit accounts of the confidential data consumers 108 and credit accounts of the confidential data collection units 100, based on the data supplied in response to queries. Alternatively, the functionality of the payment manager may be incorporated into the data sharing interface 106.

As described hereinabove in FIG. 3, a confidential data consumer unit 108 requests confidential data relative to a specific individual entity 110. In block 400, the data sharing interface 106 processes a request by receiving responses from the data collection unit interfaces 102. Each data collection unit 100, in the plurality of data collection units, either provides data relative to the specific individual entity 110 or responds with an ‘entity not found’ response. In block 402, the data sharing interface 106 is operative to create a transaction record for each data collection unit 100 that provides data in response to the query. These transaction records are then transmitted, in block 404, to the payment manager, which, in block 406, creates the debit and credit entries in the accounts of the data consumer unit 108 and the data collection unit 100, respectively. The balances in these accounts may be settled by any appropriate method, such as through cash payment or barter arrangement, based on agreement with the confidential information sharing system provider.

In accordance with another preferred embodiment of the present invention, the payment manager may be operative to debit and credit the data consumer unit 108 and the individual entity 110, respectively, for access to the data, or to process any other authorized payments.

Additionally, the payment manager may also transmit information relative to payment accounts, such as account balances, to the data collection units 100 or the data consumer units 108 through the data sharing interface 106.

Reference is now made to FIG. 5, which is a simplified flow chart of a profiling function, which forms part of a confidential information sharing system constructed and operative in accordance with a preferred embodiment of the present invention. In this embodiment, the data sharing interface 106 communicates with a profiling manager, which utilizes at least one of a multiplicity of profiling agents to generate profile based information targeted to the individual entities 110 relative to themselves, based on the data supplied in response to individual entity specific queries. Alternatively, the functionality of the profiling manager may be incorporated into the data sharing interface 106.

As described hereinabove in FIG. 3, a confidential data consumer unit 108 requests confidential data relative to a specific individual entity 110. In this instance, the data consumer unit 108 is the individual entity 110, requesting data relative to itself, in block 500. In block 502, the data sharing interface 106 processes the request by receiving responses from the data collection unit interfaces 102. The data sharing interface 106 then transmits the data to the profiling manager, in block 504. In block 506, the profiling manager processes the data, preferably using an expert/decision system or other suitable method, to generate an individual entity profile. In block 508, the individual entity profile is then transmitted to the data sharing interface 106, which then utilizes the individual entity profile to generate content specific to the individual entity 110 based on its confidential data. This individual entity specific content may be provided to the individual entity 110 by the data sharing interface 106 in the form of on-line links to information that might be of specific interest to the individual entity 110, where the individual entity 110 would preferably remain anonymous until those links were activated.

Reference is now made to FIG. 6A, which is a simplified flow chart of an embodiment of an advertising function, which forms part of a confidential information sharing system constructed and operative in accordance with another preferred embodiment of the present invention. In this embodiment, the data sharing interface 106 communicates with an advertising manager, which utilizes at least one of a multiplicity of advertising agents to generate advertising targeted to specific individual entities 110, based on the data supplied in response to individual entity specific queries. Alternatively, the functionality of the advertising manager may be incorporated into the data sharing interface 106.

As described hereinabove in FIG. 3, a confidential data consumer unit 108 requests confidential data relative to a specific individual entity 110. In this instance, the data consumer unit 108 is the individual entity 110, requesting data relative to itself in block 600. In block 602, the data sharing interface 106 processes the request by receiving responses from the data collection unit interfaces 102. The data sharing interface 106 then transmits the individual entity data to the advertising manager, in block 604. In block 606, the advertising manager processes the data using an expert/decision system or other suitable method to generate individual entity specific advertising, such as product and/or service offers based on prior purchasing trends.

In another embodiment of the present invention, the advertising manager communicates with the profile manager, described hereinabove in reference to FIG. 5, to generate an individual entity profile prior to generating the individual entity specific advertising. Alternatively, the functionality of the advertising manager and the profiling manager may be incorporated into one advertising and profiling manager, which may be incorporated into the data sharing interface 106.

In block 608, the individual entity specific advertising is then transmitted to the data sharing interface 106, which then transmits the individual entity specific advertising to the individual entity 110. This individual entity specific advertising may be provided to the individual entity 110 by the data sharing interface 106 in the form of on-line links to specific offers from advertisers that might be of interest to the individual entity 110 or in any other suitable format.

Reference is now made to FIG. 6B, which is a simplified flow chart of another embodiment of an advertising function, forming part of a confidential information sharing system. In this embodiment, the data sharing interface 106 communicates with an advertising manager, which utilizes at least one of a multiplicity of advertising agents to generate advertising targeted to confidential data consumer units 108 relative to a specific individual entity 110, with the permission of the individual entity 110, based on the data supplied in response to individual entity specific queries. Alternatively, the functionality of the advertising manager may be incorporated into the data sharing interface 106.

As described hereinabove in FIG. 3, a confidential data consumer unit 108 requests confidential data relative to a specific individual entity 110, with the permission of specific individual entity 110, in block 620. In block 622, the data sharing interface 106 processes a request by receiving responses from the data collection unit interfaces 102. The data sharing interface 106 then transmits the individual entity data to the advertising manager, in block 624, with a request for data consumer unit advertising relative to specific individual entity 110. In block 626, the advertising manager processes the data using an expert/decision system or other suitable method to generate advertising targeted to the data consumer unit 108 relative to specific individual entity 110, such as product and/or service offers they could provide to the specific individual entity based on their prior purchasing trends or credit history.

In another embodiment of the present invention, the advertising manager communicates with the profile manager, described hereinabove in reference to FIG. 5, to generate an individual entity profile prior to generating the data consumer unit advertising. Alternatively, the functionality of the advertising manager and the profiling manager may be incorporated into one advertising and profiling manager, which may be incorporated into the data sharing interface 106.

In block 628, the data consumer unit advertising is then transmitted to the data sharing interface 106, which then transmits the data consumer unit advertising to the data consumer unit 108. This data consumer unit specific advertising may be provided in the form of on-line links to specific offers that the data consumer unit 108 might offer to the individual entity 110 or in any other suitable format.

In accordance with another preferred embodiment, the advertising manager would communicate with the payment manager, which would then process payments from advertisers for each advertisement generated.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1-191. (canceled)

192. A commercial system comprising:
a first plurality of credit confidential data collection units, each collecting confidential credit data regarding a second plurality of individual entities; and
at least one credit confidential data receiver, receiving credit confidential data from ones of said first plurality of confidential data collection units regarding ones of said second plurality of individual entities and for directing offers to said ones of said second plurality of individual entities based on said credit confidential data specific to each of said ones.

193. A commercial system according to claim 192 and wherein said at least one credit confidential data receiver receives said credit confidential data only following completion of a privacy waiver.

194. A commercial system according to claim 192 and also comprising an automatic targeted advertising functionality for targeting said at least one credit confidential data receiver in accordance with at least one characteristic thereof.

195. A commercial system according to claim 192 and also comprising an individual entity interface enabling individual ones of said second plurality of individual entities to obtain access to confidential data relating to themselves, said individual entity interface including an individual entity annotation input functionality, enabling individual ones of said second plurality of individual entities to enter annotations to said confidential data relating to themselves, said individual entity annotation input functionality enabling individual ones of said second plurality of individual entities to store information relating to themselves, which information may be made available together with said confidential data.

196. A confidential information sharing system comprising:
a first plurality of data collection units, each collecting confidential data regarding a second plurality of individual entities;
a third plurality of data consumer units which intermittently require confidential data collected by ones of said first plurality of data collection units regarding ones of said second plurality of individual entities; and
at least one confidential data sharing interface, responsive to a requirement from one of said third plurality of data consumer units for confidential data from one of said first plurality of data collection units regarding one of said second plurality of individual entities, to pull confidential data from an appropriate one of said first plurality of data collection units regarding a specific individual entity.

197. A confidential information sharing system according to claim 196 and wherein said at least one confidential data sharing interface comprises payment functionality including functionality for processing payments to said first plurality of confidential data collection units in respect of confidential data collected therefrom.

198. A confidential information sharing system according to claim 196 and wherein said at least one confidential data sharing interface includes a cash payment functionality.

199. A confidential information sharing system according to claim 196 and wherein said at least one confidential data sharing interface includes a barter functionality.

200. A confidential information sharing system according to claim 196 and wherein said at least one confidential data sharing interface includes advertising functionality.

201. A confidential information sharing system according to claim 200 and wherein said advertising functionality includes automatic targeted advertising functionality for targeting ones of said third plurality of confidential data consumer units in accordance with at least one characteristic thereof.

202. A method for sharing confidential information comprising:
collecting confidential data regarding a first plurality of individual entities from a second plurality of data collection units;
storing said confidential data; and
sharing said confidential data, via at least one confidential data sharing interface, said sharing comprising:
receiving a request, from one of a third plurality of data consumer units, for individual entity specific confidential data regarding one of said first plurality of individual entities from at least one of said second plurality of data collection units;
collecting said individual entity specific confidential data from appropriate ones of said second plurality of data collection units; and
transmitting said individual entity specific confidential data to said one data consumer unit.

203. A method for sharing confidential information according to claim 202 and wherein said sharing also comprises processing payments to said second plurality of confidential data collection units in respect of confidential data collected therefrom.

204. A method for sharing confidential information according to claim 202 and wherein said sharing also includes transmitting information relating to an individual entity classification based on automatic profiling based on said confidential data.

205. A method for sharing confidential information according to claim 202 and wherein said sharing includes sharing via a distributed network including remote databases as well as segmented databases.
